(19) United States
(12) Patent Application Publication
(10) Pub. No.: US 2026/0350773 A1
(43) Pub. Date: Nov. 5, 2026

(54) Active perception and maintenance system and method

(71) Applicants: Shiyan Hu, Shenzhen (CN); Kaifeng Ji, Shenzhen (CN); Jing Xia, Shenzhen (CN); Dongmei Qiu, Shenzhen (CN)

(72) Inventors: Shiyan Hu, Shenzhen (CN); Kaifeng Ji, Shenzhen (CN); Jing Xia, Shenzhen (CN); Dongmei Qiu, Shenzhen (CN)

(21) Appl. No.: 19/408,437

(22) Filed: Dec. 4, 2025

(30) Foreign Application Priority Data
Sep. 18, 2025 (CN) 202511344132.0

(51) Int. Cl. G06T 7/00; G06V 10/25

(52) U.S. Cl. CPC G06T 7/0004; G06V 10/25

(57) ABSTRACT

An active perception and maintenance system and method are provided, which are applied to a metro bogie. The system is composed of a moving module, an execution module, a perception module, and a computing module. The computing module includes a target detection unit, a semantic comprehension unit, a task analysis unit, and a collaborative control unit. A closed loop from a task to a view to control is implemented by combining environmental perception and communication. The method includes acquisition, perception, strategy generation, and collaborative execution. Control information is outputted based on target perception information, semantic determination information, and task strategy information, and repositioning, trajectory adjustment, and supplementary imaging are completed. In a blocking or vibration scenario, visibility and imaging stability are improved through base repositioning, fine joint adjustment, and attitude compensation. Compared with manual and hierarchical control, the method reduces rephotographing and misjudgment, and improves efficiency, safety, and traceability.

### TECHNICAL FIELD

The present disclosure relates to the field of engineering maintenance, and in particular, to an active perception and maintenance method and system.

### BACKGROUND

Existing metro bogie maintenance mainly relies on manual visual inspection and handheld imaging equipment, or cameras arranged at fixed stations for passive acquisition. A small number of scenarios have introduced general-purpose target detection algorithms for initial screening of defects. However, in typical maintenance environments (such as a narrow maintenance tunnel, blocking of components such as a frame girder, and a braking system, light reflection by a plurality of oil stains, and vibrations caused by train entering or exiting), key components such as a connection between an axle box and a frame, a suspension connection, and a brake pull rod end are often located in compact and severely blocked positions, with a short sighting distance, non-uniform lighting, and strong reflection, making it difficult to obtain complete information required for determination in a single perspective (for example, details of threaded surfaces and anti-loosening markings need to be clearly presented). Therefore, even if a detection model is deployed, frequent manual rephotographing and fine pose adjustment are still required, and the overall process follows a cycle of “passive waiting-local photographing-unstable results-rework”.

At the engineering implementation level, there are still systemic technical shortcomings: first, the problems of insufficient visibility and multiple blocking objects are prominent; and there are no multi-view planning for hidden parts and a mechanism for selecting a “next best view (NBV)”. Second, perception and execution are separated. A common approach is to split chassis (trolley, platform, robot dog, and robot) movement, mechanical arm positioning, camera imaging, and the like into serial links, so that there is no unified decision-making center, making it difficult to immediately drive linked adjustment on poses and image capturing based on a detection result. A pose error and shaking transmission are involved in the third shortcoming. Under unstructured terrain and vibration interference, small attitude changes of a base can be amplified along a control link, causing unstable imaging and repeated acquisition. Fourth, alignment of semantic layers is insufficient, and it is difficult to directly map the detection result to standard parameters and maintenance key points (model number, specification, tolerance, fastening state, and the like). It is difficult to make an executable maintenance policy. Fifth, it is hard to uniformly balance safety and resource constraint. Paths, obstacle avoidance, stability margins, time, energy consumption, and the like are separately processed based on an empirical rule. This affects the efficiency and the consistency.

With the above factors, the existing solutions generally have high omission rate, high misjudgment rate, uncontrollable maintenance time, high dependence on operator skills, weak recording and traceability, and the like, especially when small-scale details (such as a bolt head with a diameter of about 20 mm and its threaded surface) need to be confirmed. These problems directly correspond to urgent needs of the industry for visibility assurance, closed-loop linkage decision-making, stable imaging, and implementation from semantics to execution.

### SUMMARY

The present disclosure aims to solve the above problems during metro bogie maintenance of insufficient visibility for key components, uncontrollable imaging quality, easy transferring and accumulation of link errors, and lack of maintenance task-oriented multi-view planning and a path and attitude collaboration mechanism.

According to one aspect of the present disclosure, an active perception and maintenance system is provided, applied to maintenance and detection of a metro bogie and including a moving module, an execution module, a perception module, and a computing module. One end of the execution module is fixedly arranged on the moving module, and another end of the execution module is connected with the perception module; the computing module is communicatively connected to the moving module, the execution module, and a camera; the computing module includes:
a target detection unit, configured to: detect and position a target component in an image obtained by the perception module, and generate and output target perception information;
a semantic comprehension unit, configured to: perform semantic analysis and determination on an attribute and a fault state of the target component based on the target perception information, and generate and output semantic determination information;
a task analysis unit, configured to: perform analysis and strategy generation on a maintenance task based on the semantic determination information, and generate and output task strategy information; and
a collaborative control unit, configured to: output control information based on the target perception information, the semantic determination information, and the task strategy information, control repositioning of the moving module and attitude and trajectory control of the execution module, and drive the camera to obtain a supplementary image.

Preferably, the system further includes an environmental perception unit, arranged on the moving module and configured to obtain the environmental perception information which includes an obstacle distribution, a passable region, and drop information; and
correspondingly, the collaborative control module also jointly generates the control information based on the environmental perception information, the target perception information, the semantic determination information, and the task strategy information, and performs path planning, obstacle avoidance, and stable standing posture control.

Preferably, the computing module is further provided with a communication unit for bidirectional data transmission between the computing module and a remote control center and receiving a control instruction issued by the remote control center; and
correspondingly, the collaborative control module jointly generates the control information based on the control instruction, the target perception information, the semantic determination information, and the task strategy information.

The present disclosure further provides an active perception and maintenance method, applied to the above active perception and maintenance system and including:
S10: acquiring image data of the target component through the perception module;
S20: analyzing the image data, detecting and positioning the target component, generating the target perception information, and extracting attribute information;
S30: generating the task strategy information based on the attribute information and in conjunction with the maintenance task; and
S40: generating the control information based on the task strategy information, and transmitting the control information to the moving module and the execution module, to implement repositioning and attitude and trajectory adjustment.

Preferably, the positioning the target component in S20 includes:
S21: preprocessing the image data, including distortion correction and brightness/contrast normalization, to obtain a preprocessed image;
S22: determining a region of interest of the target component from the preprocessed image;
S23: setting an observation quantity for pose estimation within the region of interest, and calculating a position and an attitude of the target component in a camera coordinate system based on the observation quantity; and
S24: generating the target perception information which at least includes the position, the attitude, and a target type, and extracting the attribute information from the region of interest.

Preferably, S30 includes:
S31: analyzing the maintenance task, and extracting the target component, an inspection item, a determination requirement, and a priority;
S32: performing a corresponding action on the maintenance task to the attribute information and a standard parameter database to determine a key feature to be observed and a determination index;
S33: based on the attribute information and current visibility, evaluating a view benefit and selecting a photographing pose sequence;
S34: setting a repositioning parameter and a trajectory constraint for the moving module and the execution module to form a candidate action plan;
S35: determining an imaging parameter, a visibility threshold, and a stop condition of the perception module; and
S36: generating and outputting the task strategy information which at least includes the photographing pose sequence, the repositioning parameter, the trajectory constraint, the imaging parameter, the threshold, and the stop condition.

Preferably, S40 includes:
S41: generating position points, path segments, a linear velocity, an angular velocity, and a standing posture stability constraint for the moving module based on the repositioning parameter and a safety boundary;
S42: generating a joint target, a velocity, an acceleration amplitude limit, and an obstacle detouring trajectory of the execution module based on the trajectory constraint;
S43: performing time alignment on moving control and execution control, and determining a sequence relationship of an action segment, a waiting segment, and imaging triggering, to form integrated control information; and
S44: respectively transmitting the control information to the moving module and the execution module, and controlling the perception module to perform supplementary imaging based on the imaging parameter.

Preferably, after S40, the method further includes:
S45: in an execution process, continuously verifying a collision distance, a tipping stability margin, a limiting state, and a link state; if the collision distance, the tipping stability margin, the limiting state, and the link state do not meet standards, generating rewritten control information for obstacle avoidance, speed reduction, or pausing; and
S46: receiving pose and imaging quality feedbacks, comparing the feedbacks with the threshold, and if the feedbacks do not reach the threshold, returning to S41 to update the control information and perform iterative execution until a preset determination condition is satisfied.

Preferably, the preset determination condition is jointly determined based on the task strategy information, the standard parameter database, and operation environment evaluation, specifically including:
visibility and key view coverage meet requirements;
imaging quality reaches a specified level;
pose and measurement precision meets a precision requirement;
a safety and compliance constraint meets a set safety margin and a consistency standard;
resource consumption and an execution time limit do not exceed limits; and
environment and communication stability remains within a permitted range.

Preferably, for a blocked target component, the generating the control information in S40 includes:
using a base repositioning and fine joint adjustment collaboration strategy to make a visibility proportion of the target within the region of interest meet a minimum visibility requirement stipulated in the task strategy information; and
when a base attitude disturbance is detected, the control information further includes a reverse compensation instruction to keep a normal angle of an optical axis of the perception module relative to a target surface not exceeding a preset error threshold, to obtain the supplementary image that meets imaging quality and determination requirements.

The present disclosure has the following beneficial effects: at the system level, an integrated architecture is composed of the moving module, the execution module, the perception module, and the computing module, and units such as the target detection unit, the semantic comprehension unit, the task analysis unit, and the collaborative control unit are set inside the computing module; and at the method level, a main process includes “acquisition, perception, strategy generation, and collaboration”. The control information is generated based on the task strategy information, and a closed loop is generated for iteration. The visibility and the key view coverage in a blocked and narrow space are significantly improved. Stable imaging and reduced rephotographing are implemented under vibrations and attitude disturbances. A detection result is directly converted into movement, attitude and trajectory control to reduce error transmission and improve efficiency and consistency. Furthermore, path planning, obstacle avoidance, and working safety are enhanced through environmental perception and remote linkage, thus implementing efficient, stable, and low-leakage active maintenance and detection of key components of a bogie.

### BRIEF DESCRIPTION OF THE DRAWINGS

To describe the technical solutions in the implementations of the present application or in the related art more clearly, the following briefly introduces the accompanying drawings for describing the implementations or the related art. Apparently, the accompanying drawings in the following description show merely some implementations of the present application, and a person of ordinary skill in the art may still derive other drawings from the accompanying drawings without creative efforts.

FIG. 1 is a logic block diagram of an active perception and maintenance method according to an implementation of the present disclosure.

### DETAILED DESCRIPTION OF THE EMBODIMENTS

In order to facilitate understanding the present disclosure, the present disclosure will be described more comprehensively below with reference to related accompanying drawings. Preferred implementations of the present disclosure are provided in the accompanying drawings. However, the present disclosure can be implemented in many different forms, and are not limited to the implementations described herein. On the contrary, these implementations are provided to make the content disclosed in the present disclosure understood more thoroughly and comprehensively.

Unless otherwise defined, all technical and scientific terms used herein have the same meaning as those commonly understood by a person skilled in the art to which the present disclosure belongs. Terms used in the specification of the present disclosure herein are merely intended to describe objectives of the specific implementations, but are not intended to limit the present application. The term “and/or” used herein includes any and all combinations of one or more related listed items.

An implementation of the present disclosure provides an active perception and maintenance system, applied to maintenance and detection of a metro bogie and including a moving module, an execution module, a perception module, and a computing module. One end of the execution module is fixedly arranged on the moving module, and another end of the execution module is connected with the perception module; the computing module is communicatively connected to the moving module, the execution module, and a camera; the computing module includes:
a target detection unit, configured to: detect and position a target component in an image obtained by the perception module, and generate and output target perception information;
a semantic comprehension unit, configured to: perform semantic analysis and determination on an attribute and a fault state of the target component based on the target perception information, and generate and output semantic determination information;
a task analysis unit, configured to: perform analysis and strategy generation on a maintenance task based on the semantic determination information, and generate and output task strategy information; and
a collaborative control unit, configured to: output control information based on the target perception information, the semantic determination information, and the task strategy information, control repositioning of the moving module and attitude and trajectory control of the execution module, and drive the camera to obtain a supplementary image.

In this embodiment, it should be noted that the active perception and maintenance system is an integrated architecture composed of a moving module, an execution module, a perception module, and a computing module. The execution module is preferably a mechanical arm which is stably mounted on a bearing platform of the moving module. The moving module is preferably a robot dog or a robot, specifically a quadruped robot dog or a bipedal robot, which is provided with the bearing platform. The perception module is preferably a camera mounted on an end effector of the mechanical arm. A view and a distance can be flexibly configured by adjusting an attitude of the mechanical arm. The computing module is respectively communicatively connected to the moving module, the execution module, and the perception module, and internally integrates a target detection unit, a semantic comprehension unit, a task analysis unit, and a collaborative control unit. In a working flow, an image acquired in real time by the camera first enters the target detection unit to generate target perception information (such as a position, an attitude, a type, and a visibility index). Based on this, the semantic comprehension unit outputs semantic determination information (such as a model number, a specification, assembling, a compliance indication, a fault sign, and a level). The task analysis unit further generates task strategy information (such as a photographing pose sequence, movement and repositioning parameter, an attitude, a trajectory constraint, an imaging parameter, quality, a visibility threshold, and a stop condition). The collaborative control unit synthesizes the three types of information to generate control information which is transmitted to the moving module and the execution module respectively, to complete repositioning and joint attitude and trajectory control, and instructs the perception module to perform supplementary image capturing based on an imaging parameter, so as to still obtain an image that meets a determination requirement under working conditions such as blocking, lighting changes, or vibrations. In this embodiment, the computing module can be arranged on a mobile platform body, or can be linked with a remote control center through a data link to implement edge and cloud collaborative processing. A communication manner can be wired or wireless, and is not limited to this. To improve coordinate consistency, the system can perform camera calibration and hand-eye extrinsic parameter calibration. If necessary, an environmental perception unit and an attitude sensor can also be configured to provide attitude information of an obstacle, a passable region, and a base, thus enhancing path planning and imaging stability (both of which are equivalent replacements or additional optimizations).

The implementation of the technical solution of this embodiment can implement targeted improvement on the problems such as “insufficient visibility, unstable imaging, and perception-execution separation”. First, through the collaboration of the “moving module+the camera at the end of the mechanical arm”, the line of sight is actively expanded to reach hidden parts blocked by a frame girder, thus improving key view coverage and effective visibility, and reducing rework and rephotographing. Second, by relying on a “target detection-semantic comprehension-task analysis-collaborative control” link, a recognition result is directly converted into control information for repositioning and attitude and trajectory control, thus forming a closed-loop linkage from task to view and from perception to execution, which reduces error transmission and improving efficiency and consistency. Third, in conjunction with an imaging parameter and quality and visibility threshold constraints, imaging stability and reliable determination are kept under vibrations and lighting disturbances, and environment and attitude information can be introduced to improve path planning and standing posture stability. A structural foundation for a modular system and unit level linkage is provided, and a method flow and a closed-loop mechanism of “acquisition-perception-strategy-collaboration” is provided, which jointly achieve efficient, stable, and low-leakage active maintenance and detection on key components of a bogie.

Further, the system further includes an environmental perception unit, arranged on the moving module and configured to obtain the environmental perception information which includes an obstacle distribution, a passable region, and drop information.

Correspondingly, the collaborative control module also jointly generates the control information based on the environmental perception information, the target perception information, the semantic determination information, and the task strategy information, and performs path planning, obstacle avoidance, and stable standing posture control.

In this embodiment, it should be noted that the system is added with the environmental perception unit mounted on the moving module to obtain the environmental perception information in real time, which at least includes an obstacle distribution, a passable region, and drop information. The environmental perception unit can be one or more of a laser radar, a millimeter-wave radar, and a depth camera, and is time-synchronized and coordinate-aligned with a moving module odometer and an inertial measurement unit (IMU). The computing module integrates the environmental perception information with the target perception information, the semantic determination information, and the task strategy information to generate a cost map and position candidate set with a safety boundary, so as to dynamically evaluate path feasibility, obstacle crossing, a drop crossing condition, and a standing posture stability margin. The collaborative control module generates the control information based on an integration result, completes path planning, obstacle avoidance decision-making, and stable standing posture control, and triggers base repositioning and an obstacle detouring trajectory of the mechanical arm if necessary, so that the camera obtains the supplementary image that satisfies visibility and imaging quality thresholds.

The implementation of the technical solution of this embodiment can significantly improve working safety and an imaging success rate in narrow workstations, complex blocking scenarios, and drop scenarios. In one aspect, by using the passage region and an obstacle boundary that are provided by the environmental perception unit, feedforward constraints on paths and positions can be achieved, thus lowering a risk of ineffective movement and collision. In another aspect, the collaborative control module balances environmental limitation, task priority, and visibility target to ensure that movement and an action of the mechanical arm are collaboratively converged to a stable standing posture and an effective view, thus reducing a probability of rephotographing and leakage, and maintaining imaging stability and maintenance consistency in case of vibrations or attitude disturbances.

Further, the computing module is further provided with a communication unit for bidirectional data transmission between the computing module and a remote control center and receiving a control instruction issued by the remote control center. Correspondingly, the collaborative control module jointly generates the control information based on the control instruction, the target perception information, the semantic determination information, and the task strategy information.

In this embodiment, it should be noted that the computing module integrates the communication unit for establishing a bidirectional data link with the remote control center. The communication unit can support various transmission manners such as a cellular network, a private network, Wi-Fi, etc., and has link state monitoring, reconnection of a disconnected link, and bandwidth adaptation. A camera image, the target perception information, the semantic determination information, the task strategy information, an execution log, and an attitude and environment data can be uploaded in real time or in batches in an up direction. The control instruction, a parameter update, a strategy template, and task orchestration can be received in a down direction. To ensure temporal consistency, the communication unit performs timestamp marking, buffering, and retransmission control on key information, and employs a compression or abstract uploading mode in a low bandwidth scenario. Encryption and permission verification can be enabled for security purposes. After receiving the control instruction, the computing module integrates the control instruction with a local perception and a strategy result. The collaborative control module generates the control information and transmits the control information to the moving module and the execution module while backhauling an execution feedback to form an end-cloud collaborative closed loop. It is automatically switched to a local closed-loop mode when the link is abnormal, and differential synchronization is performed after recovery.

The implementation of the technical solution of this embodiment can implement coordinated unifying of remote commanding and local autonomy: a central side transmits tasks and parameters to quickly unify a maintenance caliber and supports human-computer collaborative review, and cloud-edge collaboration completes heavy load inference and strategy optimization on the central side, thereby reducing on-site computing power and time consumption. Link monitoring and local closed-loop redundancy improve availability and working safety in a complex electromagnetic and closed station environment and consistency and traceability of full-process data backhaul and an audit enhancement result. In a parallel operation scenario of a plurality of vehicle groups, overall maintenance efficiency and collaborative quality can also be improved through remote task arrangement and resource scheduling.

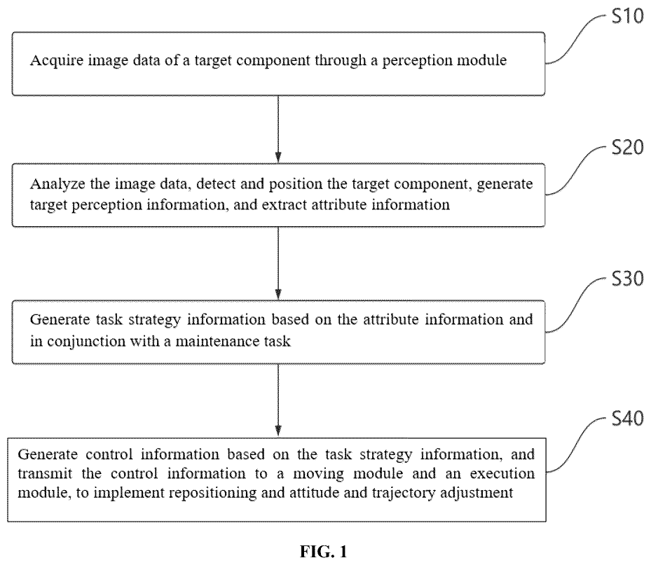

As shown in FIG. 1, an embodiment of the present disclosure provides an active perception and maintenance method, applied to the above active perception and maintenance system and including:
S10: Acquire image data of the target component through the perception module. In this step, it should be noted that the perception module performs image acquisition, and the camera mounted at the end of the mechanical arm starts to capture images after the moving module and the execution module are collaboratively positioned. To ensure data availability, camera calibration and hand-eye extrinsic parameter calibration are preferentially completed, and timestamp marking is performed on acquired data to synchronize attitude data such as an odometer and an IMU. In a complex lighting and vibration environment, automatic exposure, gain, and stabilization settings are triggered, and light filling is started if necessary. For subsequent processing, the acquired data is transmitted to a data channel of the computing module in a frame stream or batch manner, and basic metadata (a photographing standing posture, a focal length, a clarity evaluation result, and the like) is retained.
S20: Analyze the image data, detect and position the target component, generate the target perception information, and extract attribute information. In this step, it should be noted that the computing module analyzes the image data, completes the detection and positioning of the target component, and forms the target perception information. The information at least includes one or more of a pose, a type, and a visibility index. Meanwhile, key elements (such as a geometric scale, a model number, an identifier, and an assembling instruction) in the attribute information are extracted from a detected region of interest. To improve positioning stability, multi-frame observation or multi-view results can be integrated, and uncertainty evaluation can be provided to drive next strategy generation and determination of whether to perform rephotographing.
S30: Generate the task strategy information based on the attribute information and in conjunction with the maintenance task. In this step, it should be noted that the computing module maps a key feature to be observed and a determination requirement based on the attribute information and in conjunction with the maintenance task, and the task strategy information is generated. This information includes a view, a photographing pose sequence, a movement and repositioning parameter, a mechanical arm attitude, a trajectory constraint, an imaging parameter, visibility and imaging quality thresholds, a stop condition, a priority, and the like, to guide orders and ranges of subsequent actions and supplementary imaging.
S40: Generate the control information based on the task strategy information, and transmit the control information to the moving module and the execution module, to implement repositioning and attitude and trajectory adjustment. In this step, it should be noted that the computing module generates the control information based on the task strategy information and transmits the control information to the moving module and the execution module. The control information includes position points and path segments, a linear or angular velocity, a standing posture stability constraint, an acceleration amplitude limit, an obstacle detouring trajectory, and the like. Meanwhile, time alignment is performed on movement and joint actions, to clarify a temporal relationship between an action segment, a waiting segment, and imaging triggering, and guide the perception module to complete supplementary image capturing based on the imaging parameter. In the execution process, online verification can be performed by combining a safety boundary with a link state. If necessary, the control information can be rewritten to implement obstacle avoidance, speed reduction, or pausing.

The implementation of the technical solution of this embodiment can significantly improve the key view coverage and image visibility in a blocked and narrow station. Through a closed-loop of “acquisition-perception-strategy-collaboration”, a recognition result is directly converted into movement and attitude and trajectory control, thus reducing rephotographing and false detection. The imaging stability and reliable determination are maintained in vibration and light disturbance environments, and working safety and overall maintenance efficiency are improved under path, obstacle avoidance, and standing posture constraints.

Further, the positioning the target component in S20 includes:
S21: Preprocess the image data, including distortion correction and brightness/contrast normalization, to obtain a preprocessed image. In this step, it should be noted that imaging preprocessing is performed on the image data to improve stability of subsequent positioning and recognition. The preprocessing includes lens distortion correction (restoring a geometric shape based on internal parameters and distortion coefficients of the camera) and normalization of brightness and contrast (for example, alleviating shadows and reflection differences based on histogram equalization or adaptive equalization), and can be combined with denoising and sharpening to suppress motion blurring and high-frequency noises. During the preprocessing of the image, a timestamp, a photographing pose, and other metadata are maintained, which is convenient for subsequent multi-frame integration and coordinate alignment.
S22: Determine a region of interest of the target component from the preprocessed image. In this step, it should be noted that the region of interest is determined from the preprocessed image to focus on effective pixels related to the target component. The region of interest can be obtained from a bounding box, a segmentation mask, or a keypoint neighborhood that is outputted by the target detection unit, and can be expanded outwards based on a preset boundary coefficient to cover edge features and a focus reference. For a blocked scenario or a scenario with a scale difference, a plurality of regions of interest can be generated and sorted based on visibility or confidence as a priority region set for subsequent pose estimation and supplementary image capturing.
S23: Set an observation quantity for pose estimation within the region of interest, and calculate a position and an attitude of the target component in a camera coordinate system based on the observation quantity. In this step, it should be noted that the observation quantity for pose calculation is set within the region of interest, and the position and the attitude of the target component in the camera coordinate system are calculated. The observation quantity can include a geometric edge, a corner, a feature point, a semantic keypoint, or a planar feature. After a correspondence relationship between two-dimensional observation and a three-dimensional benchmark feature is established, robust estimation is used to eliminate outer points, thus solving a pose with six degrees of freedom. For a planar or quasi planar structure, normal and in-plane orientations can be restored through homography. When depth or point cloud data is available, three-dimensional segmentation and model registration can be performed within a voxel of interest to refine the pose. Multi-view or multi-time observation can reduce a deviation caused by blocking and noises through joint optimization.
S24: Generate the target perception information which at least includes the position, the attitude, and a target type, and extract the attribute information from the region of interest. In this step, it should be noted that after obtaining the position and the attitude, the target perception information is generated, and the attribute information is extracted from the region of interest. The target perception information at least includes the position, the attitude, and the type, and can optionally include a visibility index, a blocking proportion, and an uncertainty measure for use in strategy and control stages. The attribute information focuses on an objective attribute of the target, such as a geometric scale, a model number, an identifier, an assembling indication or a color, and a coating mark, for subsequent comparison with standard parameters or knowledge base entries. Two types of information are outputted in a structured form for direct reference in task analysis and collaborative control.

The implementation of the technical solution of this embodiment can obtain a high-quality input, accurately define a target range, and reliably solve the pose with the six degrees of freedom pose a complex lighting and blocking condition. Meanwhile, structurally outputting key information such as the pose, the type, and the attribute provides a consistent and traceable data foundation for subsequent view planning and control instruction generation, thereby reducing a probability of repeated image capturing and misjudgment and improving maintenance efficiency and determination reliability.

Further, S30 includes:
S31: Analyze the maintenance task, and extract the target component, an inspection item, a determination requirement, and a priority. In this step, it should be noted that the maintenance task is analyzed to convert a natural language or a templated task into a structured field which at least includes the target component, a position, an inspection item, a determination requirement, a priority, a time limit, and the like. Meanwhile, a task range (mandatory inspection, random sampling), an operation window (a train state, a station state), a safety boundary (a no-entry zone, a maximum speed, a minimum safe distance), and a data retention requirement (a number of captured frames, an evidence image list) are specified, thus providing a unified entry for subsequent strategy generation.
S32: Perform a corresponding action on the maintenance task to the attribute information and a standard parameter database to determine a key feature to be observed and a determination index. In this step, it should be noted that the corresponding action is performed on the maintenance task to the attribute information and the standard parameter database, to specific the key feature to be observed and the quantifiable determination index, such as a model number, a dimensional tolerance corresponding to a specification, a number of exposed threads of a fastener, a marker line alignment deviation, and a minimum detectable size. Meanwhile, a comparison manner (threshold, range, template similarity) is determined, and executable determination table entries and weights are outputted to guide views and imaging configurations.
S33: Based on the attribute information and current visibility, evaluate a view benefit and select a photographing pose sequence. In this step, it should be noted that the photographing pose sequence is selected by evaluating benefits of candidate views based on the attribute information and current visibility and considering factors such as a blocking proportion, a target proportion, an information gain, motion costs, and a safety margin. If necessary, a “next best view” and a return view are configured for a concealed surface, and a position, a lens-target distance, a line-of-sight angle, and an image capturing sequence are specified for each pose, to ensure that the key feature is fully covered within acceptable costs.
S34: Set a repositioning parameter and a trajectory constraint for the moving module and the execution module to form a candidate action plan. In this step, it should be noted that the repositioning parameter and the trajectory constraint are set for the moving module and the execution module to form the candidate action plan. The constraint includes a maneuvering channel and a position region, an upper limit of a linear or angular velocity, an acceleration and jerk amplitude limit, a mechanical arm joint limit and reachable region, obstacle avoidance and tipping stability margins, and the like. Meanwhile, an action synchronization relationship and a waiting condition are defined to ensure that the temporal coordination between movement and joint motion meets an imaging requirement and a safety boundary.
S35: Determine an imaging parameter, a visibility threshold, and a stop condition of the perception module. In this step, it should be noted that the determining the imaging parameter of the perception module, the visibility threshold, and the stop condition includes a focusing manner, a focal length, a working distance, exposure, gain, a light filling strategy, shutter, and noise reduction. An image quality threshold (a clarity, a contrast, a signal-to-noise ratio), the visibility threshold (an upper limit of blocking, a lower limit of a target proportion), and a completion condition (key view coverage, evidence image list completeness) are set, and rules for triggering rephotographing and termination are defined.
S36: Generate and output the task strategy information which at least includes the photographing pose sequence, the repositioning parameter, the trajectory constraint, the imaging parameter, the threshold, and the stop condition. In this step, it should be noted that the task strategy information is generated and outputted by integrating the foregoing results, at least including the photographing pose sequence, the repositioning parameter, the trajectory constraint, the imaging parameter, the threshold, and the stop condition. The task strategy information is expressed in a structured format, carries a priority and a timing sequence, and supports online adjustment and a return path, to directly drive subsequent control and supplementary imaging.

The implementation of the technical solution of this embodiment can connect “task-standardization-view-action-imaging” in series into a unified strategy link. In one aspect, the key feature and the determination index are prioritized at a strategy layer, thus effectively reducing blind photographing and ineffective motion while improving visibility and an imaging success rate. In another aspect, the pose sequence, the constraint, and the imaging parameter are collaboratively planned in a generation stage, to reduce on-site temporary adjustment and a probability of rephotographing. Meanwhile, by clarifying the threshold and the stop condition, a controllable process and a reviewable result are implemented. The maintenance efficiency, the consistency, and the traceability are overall improved.

Further, S40 includes:
S41: Generate position points, path segments, a linear velocity, an angular velocity, and a standing posture stability constraint for the moving module based on the repositioning parameter and a safety boundary. In this step, it should be noted that the position points and the path segments of the moving module are generated based on the repositioning parameter and the safety boundary, and the linear velocity, the angular velocity, and the standing posture stability constraint are specified. The position points meet requirements for a line-of-sight channel, a camera working distance, and an optical axis angle. The path segments are subjected to curvature and acceleration amplitude limit smoothing while avoiding a no-entry zone, an obstacle boundary, and a drop region. A minimum stability margin is set for the standing posture stability constraint based on a center of gravity-support domain relationship, an IMU attitude, and a ground adhesion condition. Buffer distances and deceleration segments are automatically inserted near steps and gaps, to ensure that an imaging condition is satisfied after the system is in place and stopped stably.
S42: Generate a joint target, a velocity, an acceleration amplitude limit, and an obstacle detouring trajectory of the execution module based on the trajectory constraint. In this step, it should be noted that the joint target, the velocity, and the acceleration amplitude limit of the execution module are generated based on the trajectory constraint, and the obstacle detouring trajectory is planned in case of blocking or limited reachability. In the planning process, singular poses and joint limits are detected. If necessary, automatic segmentation interpolation and pose transitioning are performed to ensure that the end is located within an image-capturable attitude window. Meanwhile, constraints are imposed on an angle between an optical axis of the camera and a normal direction of a target surface, a proportion of the target in a field of view, and a working distance range, so as to have an effective imaging geometry at the arrival of a joint target.
S43: Perform time alignment on moving control and execution control, and determine a sequence relationship of an action segment, a waiting segment, and imaging triggering, to form integrated control information. In this step, it should be noted that the time alignment and synchronous scheduling are performed on moving control and execution control to determine the sequence relationship of the action segment, the waiting segment, and the imaging triggering. The imaging triggering is only released when a position error and an end shaking threshold are satisfied, and predetermination of target visibility and clarity are satisfied. Vibration attenuation waiting or autofocus locking waiting is inserted if necessary. If any prerequisite is not satisfied, a scheduler returns to a fine-adjustment path or a fine joint adjustment branch and re-evaluates a triggering condition, thus forming a repeatable closed-loop cycle.
S44: Respectively transmit the control information to the moving module and the execution module, and control the perception module to perform supplementary imaging based on the imaging parameter. In this step, it should be noted that the integrated control information is separately transmitted to the moving module and the execution module, and the perception module is driven to complete the supplementary imaging based on the imaging parameter. The transmission process includes command confirmation and execution state acknowledgment. During execution, a collision distance, a tipping margin, and a limiting state are continuously monitored, and if necessary, the control information is rewritten to implement obstacle avoidance, speed reduction, or pausing. The supplementary imaging can be performed by using single-frame or short-sequence acquisition, and metadata such as a timestamp, a pose, a focus, and exposure is recorded for subsequent determination and tracing.

The implementation of the technical solution of this embodiment can collaboratively organize path planning, joint trajectory, and imaging triggering under a unified time sequence, thus achieving precise positioning and stable image capturing within the safety boundary. In a blocked or space-limited environment, ineffective motion and a probability of rephotographing are reduced through coordination of position and obstacle detouring, thus enhancing key perspective coverage and an imaging success rate. Under conditions of vibrations and attitude disturbances, image quality consistency and determination reliability are improved through closed-loop control of stable stopping and triggering criteria, thereby overall shortening a maintenance cycle, reducing leakage and misjudgments, and improving working safety and traceability.

Optionally, after S40, the method further includes:
S45: In an execution process, continuously verify a collision distance, a tipping stability margin, a limiting state, and a link state; if the collision distance, the tipping stability margin, the limiting state, and the link state do not meet standards, generate rewritten control information for obstacle avoidance, speed reduction, or pausing. In this step, it should be noted that the safety and an execution state are continuously monitored during the execution, and online verification and processing are performed. The collision distance is calculated based on environmental perception data and a built cost map, to compare a safety boundary in real time. The tipping stability margin is dynamically estimated based on the center of gravity-support domain relationship, the IMU attitude, and the ground adhesion estimation. The limiting state is determined jointly by a joint position, a velocity, and a soft/hard limit switch. The link state evaluates communication quality through a round-trip delay, a packet loss rate, and a bandwidth occupancy rate. When any index triggers an alert threshold, the rewritten control information is generated and is processed hierarchically: obstacle detouring or speed reduction is preferentially performed. A risk is lowered through fine adjustment on the position and the trajectory. At an upper limit, the system enters a safe shutdown or maintaining position, to wait for manual or remote confirmation or automatic replanning to resume the execution. All events are recorded with timestamps for easy tracing and reproduction.
S46: Receive pose and imaging quality feedbacks, compare the feedbacks with the threshold, and if the feedbacks do not reach the threshold, return to S41 to update the control information and perform iterative execution until a preset determination condition is satisfied. In this step, it should be noted that the pose and imaging quality feedbacks are acquired and are compared with the given threshold in the strategy to form a closed-loop decision. The pose feedback includes a base pose, six degrees of freedom of the end, and a trajectory tracking error. The imaging quality feedback includes clarity, a focusing success rate, exposure, a signal-to-noise ratio, a target proportion, and a blocking proportion. If any key index does not reach the threshold, S41 is executed to update the control information and perform iterative execution: the position points and the path segments can be adjusted, to refine the joint target and the amplitude limit, insert vibration attenuation waiting or focus locking waiting. If necessary, it switches to a backup view and a light filling plan. Meanwhile, action priorities are rearranged based on risk weights until a determination condition or a triggering stop condition is satisfied.

The implementation of the technical solution of this embodiment can build a closed-loop guarantee mechanism that integrates safety, quality, and efficiency during the execution: By continuous verification and hierarchical processing, collision and tipping risks can be prevented, thus reducing an abnormal interruption rate. Through feedback-based adaptive iteration, the pose and the imaging quality are stably converged to a target range, thus significantly reducing rephotographing and rework. Meanwhile, complete states and event records are maintained, and process traceability and result consistency are improved, thereby improving safety, reliability, and turnover efficiency of maintenance operations in complex stations and dynamic environments.

In a specific implementation, the preset determination condition is jointly determined based on the task strategy information, the standard parameter database, and operation environment evaluation, specifically including: visibility and key view coverage meet requirements;
imaging quality reaches a specified level; pose and measurement precision meets a precision requirement;
a safety and compliance constraint meets a set safety margin and a consistency standard; resource consumption and an execution time limit do not exceed limits; and environment and communication stability remains within a permitted range.

In this embodiment, it should be noted that the preset determination condition is jointly determined based on the task strategy information, the standard parameter database, and the operation environment evaluation, and is written into a strategy and control link in the form of a target value, an upper or lower limit, or a range. Determination dimensions include the visibility, the key view coverage, the imaging quality, the pose and measurement precision, the safety and compliance constraints, the resource and time limit, the environment and communication stability. The visibility dimension is based on the target proportion, the blocking proportion, and key-view completion. The imaging quality dimension is based on a comprehensive level of the clarity, the focusing success rate, the exposure, and the signal-to-noise ratio. The pose and measurement precision dimension is based on an end pose error, target pose uncertainty, and measurement repeatability. The safety and compliance constraint dimension is based on the collision distance, the stability margin, border-crossing and limitation detection, and the standard comparison consistency. The resource and time limit dimension is based on action costs, energy consumption, and the working window. The environment and communication stability dimension are based on vibrations, a temperature rise, a link delay, and a packet loss rate. The thresholds can be weighted and adjusted based on task priorities and risk levels, and are linked with control parameters such as the paths, the trajectories, the imaging triggering, and the like. During the execution, a feedback loop performs real-time verification. When the thresholds are not satisfied, repositioning is triggered, and views are finely adjusted or replaced. After the thresholds are satisfied, it exits the closed loop and solidifies maintenance conclusions and evidence data.

The implementation of the technical solution of this embodiment can consider a maintenance success or failure standard as a measurable threshold set, making the closed-loop determination objective, verifiable, and traceable. Under a complex working condition such as blocking and vibrations, subjective determination and repeated image capturing are reduced, thus significantly reducing rephotographing and false detection. While ensuring safety and compliance, the action costs and the working time are reduced, and the key view coverage rate and the imaging success rate are increased. Meanwhile, the operation robustness is improved based on the environment and communication stability constraint, so that the system maintains consistent maintenance quality and efficiency in different vehicle types, different stations, and different environments.

In a specific embodiment, for a blocked target component, the generating the control information in S40 includes:
using a base repositioning and fine joint adjustment collaboration strategy to make a visibility proportion of the target within the region of interest meet a minimum visibility requirement stipulated in the task strategy information; and
when a base attitude disturbance is detected, the control information further includes a reverse compensation instruction to keep a normal angle of an optical axis of the perception module relative to a target surface not exceeding a preset error threshold, to obtain the supplementary image that meets imaging quality and determination requirements.

In this embodiment, it should be noted that for the blocked target component, the control information generated in S40 employs a collaboration strategy of “base repositioning+fine joint adjustment”. The base repositioning is used to select new position points or slightly return or laterally move within a passable range of the station, so as to open up a line-of-sight channel and improve the visibility ratio of the target in the region of interest. The fine joint adjustment is used to finely adjust the pose of the end of the mechanical arm without changing the stability of the base, so that the imaging geometry of optical axis-target can enter a determinable range. The base repositioning and the fine joint adjustment are executed through unified time scheduling: base deceleration, stable stopping, and shaking attenuation are first completed, and then the fine joint adjustment and the imaging are triggered. The imaging triggering is controlled by thresholds of the visibility ratio and the clarity. If the visibility ratio and the clarity do not reach the thresholds, the repositioning and fine adjustment branch is executed for continuous iteration. To suppress external interference, an attitude disturbance monitoring and reverse compensation instruction is set in the control information: when the IMU detects that a base roll or pitch offset exceeds a set slight deviation angle, equal amplitude reverse compensation is transmitted to an upstream joint in real time to maintain an error of the angle between the optical axis of the camera and the normal direction of the target surface not exceeding a preset threshold. If necessary, exposure, gain, and shutter are synchronously adjusted to offset the impact of vibrations and lighting fluctuations on imaging. The entire process retains execution and imaging metadata for subsequent determination and tracing.

The implementation of the technical solution of this embodiment can significantly improve an achievement rate of a key view and a target visibility ratio under a blocked and narrow space condition, thus reducing rephotographing and rework that are caused by limited visibility. In case of attitude disturbances and vibrations, the angle between the optical axis and the normal direction is maintained by virtue of reverse compensation, so that the imaging quality reaches a level required by determination, thus improving reliability and consistency of defect determination. Meanwhile, through the link control of stable stopping, fine adjustment, and threshold-triggered imaging, ineffective motion and waiting time are reduced; maintenance efficiency is overall improved; and leakage and misjudgment risks are lowered.

The foregoing implementations merely express several implementations of the present application. The descriptions thereof are relatively specific and detailed, but are not understood as limitations on the scope of the present application. For a person of ordinary skill in the art, several transformations and improvements can be made without departing from the idea of the present disclosure. These transformations and improvements belong to the protection scope of the present disclosure. Therefore, the protection scope of the patent of the present disclosure shall be subject to the appended claims.

What is claimed is:

1. An active perception and maintenance system, applied to maintenance and detection of a metro bogie and comprising a moving module, an execution module, a perception module, and a computing module, wherein one end of the execution module is fixedly arranged on the moving module, and another end of the execution module is connected with the perception module; the computing module is communicatively connected to the moving module, the execution module, and a camera; the computing module comprises:
a target detection unit, configured to: detect and position a target component in an image obtained by the perception module, and generate and output target perception information;
a semantic comprehension unit, configured to: perform semantic analysis and determination on an attribute and a fault state of the target component based on the target perception information, and generate and output semantic determination information;
a task analysis unit, configured to: perform analysis and strategy generation on a maintenance task based on the semantic determination information, and generate and output task strategy information; and
a collaborative control unit, configured to: output control information based on the target perception information, the semantic determination information, and the task strategy information, control repositioning of the moving module and attitude and trajectory control of the execution module, and drive the camera to obtain a supplementary image.

2. The active perception and maintenance system according to claim 1, wherein the system further comprises an environmental perception unit, arranged on the moving module and configured to obtain the environmental perception information which comprises an obstacle distribution, a passable region, and drop information; and
correspondingly, the collaborative control module also jointly generates the control information based on the environmental perception information, the target perception information, the semantic determination information, and the task strategy information, and performs path planning, obstacle avoidance, and stable standing posture control.

3. The active perception and maintenance system according to claim 1, wherein the computing module is further provided with a communication unit for bidirectional data transmission between the computing module and a remote control center and receiving a control instruction issued by the remote control center; and
correspondingly, the collaborative control module jointly generates the control information based on the control instruction, the target perception information, the semantic determination information, and the task strategy information.

4. An active perception and maintenance method, applied to the active perception and maintenance system according to claim 1 and comprising:
S10: acquiring image data of the target component through the perception module;
S20: analyzing the image data, detecting and positioning the target component, generating the target perception information, and extracting attribute information;
S30: generating the task strategy information based on the attribute information and in conjunction with the maintenance task; and
S40: generating the control information based on the task strategy information, and transmitting the control information to the moving module and the execution module, to implement repositioning and attitude and trajectory adjustment.

5. The active perception and maintenance method according to claim 4, wherein the positioning the target component in S20 comprises:
S21: preprocessing the image data, comprising distortion correction and brightness/contrast normalization, to obtain a preprocessed image;
S22: determining a region of interest of the target component from the preprocessed image;
S23: setting an observation quantity for pose estimation within the region of interest, and calculating a position and an attitude of the target component in a camera coordinate system based on the observation quantity; and
S24: generating the target perception information which at least comprises the position, the attitude, and a target type, and extracting the attribute information from the region of interest.

6. The active perception and maintenance method according to claim 5, wherein S30 comprises:
S31: analyzing the maintenance task, and extracting the target component, an inspection item, a determination requirement, and a priority;
S32: performing a corresponding action on the maintenance task to the attribute information and a standard parameter database to determine a key feature to be observed and a determination index;
S33: based on the attribute information and current visibility, evaluating a view benefit and selecting a photographing pose sequence;
S34: setting a repositioning parameter and a trajectory constraint for the moving module and the execution module to form a candidate action plan;
S35: determining an imaging parameter, a visibility threshold, and a stop condition of the perception module; and
S36: generating and outputting the task strategy information which at least comprises the photographing pose sequence, the repositioning parameter, the trajectory constraint, the imaging parameter, the threshold, and the stop condition.

7. The active perception and maintenance method according to claim 6, wherein S40 comprises:
S41: generating position points, path segments, a linear velocity, an angular velocity, and a standing posture stability constraint for the moving module based on the repositioning parameter and a safety boundary;
S42: generating a joint target, a velocity, an acceleration amplitude limit, and an obstacle detouring trajectory of the execution module based on the trajectory constraint;
S43: performing time alignment on moving control and execution control, and determining a sequence relationship of an action segment, a waiting segment, and imaging triggering, to form integrated control information; and
S44: respectively transmitting the control information to the moving module and the execution module, and controlling the perception module to perform supplementary imaging based on the imaging parameter.

8. The active perception and maintenance method according to claim 4, wherein after S40, the method further comprises:
S45: in an execution process, continuously verifying a collision distance, a tipping stability margin, a limiting state, and a link state; if the collision distance, the tipping stability margin, the limiting state, and the link state do not meet standards, generating rewritten control information for obstacle avoidance, speed reduction, or pausing; and
S46: receiving pose and imaging quality feedbacks, comparing the feedbacks with the threshold, and if the feedbacks do not reach the threshold, returning to S41 to update the control information and perform iterative execution until a preset determination condition is satisfied.

9. The active perception and maintenance method according to claim 8, wherein the preset determination condition is jointly determined based on the task strategy information, the standard parameter database, and operation environment evaluation, specifically comprising:
visibility and key view coverage meet requirements;
imaging quality reaches a specified level;
pose and measurement precision meets a precision requirement;
a safety and compliance constraint meets a set safety margin and a consistency standard;
resource consumption and an execution time limit do not exceed limits; and environment and communication stability remains within a permitted range.

10. The active perception and maintenance method according to claim 8, wherein for a blocked target component, the generating the control information in S40 comprises:
using a base repositioning and fine joint adjustment collaboration strategy to make a visibility proportion of the target component within the region of interest meet a minimum visibility requirement stipulated in the task strategy information; and
when a base attitude disturbance is detected, the control information further comprises a reverse compensation instruction to keep a normal angle of an optical axis of the perception module relative to a target surface not exceeding a preset error threshold, to obtain the supplementary image that meets imaging quality and determination requirements.
